(19) United States
(12) Patent Application Publication
(10) Pub. No.: US 2021/0147725 A1
(43) Pub. Date: May 20, 2021

(54) FLAME-RETARDANT PRESSURE-SENSITIVE ADHESIVE

(71) Applicant: tesa SE, Norderstedt (DE)

(72) Inventors: Budde Felix, Hamburg (DE); Maike Strebl-Pfarr, Hamburg (DE); Vanessa Homann, Hamburg (DE)

(73) Assignee: tesa SE, Norderstedt (DE)

(21) Appl. No.: 16/950,945

(22) Filed: Nov. 18, 2020

(30) Foreign Application Priority Data
Nov. 18, 2019 (DE) 10 2019 217 753.0

(51) Int. Cl. C09J 11/06; C09J 7/38; C09J 5/00

(52) U.S. Cl. CPC C09J 11/06; C09J 7/385; C09J 5/00; C09J 2493/00; C09J 2301/302; C09J 2433/00; C09J 2301/408

(57) ABSTRACT

A pressure-sensitive adhesive having good adhesive and flame retardancy properties is provided. The pressure-sensitive adhesive comprises: (A) at least one poly(meth)acrylate and (B) at least one organophosphorus compound, wherein the monomer composition forming the basis for the poly(meth)acrylate comprises (i) at least one (meth)acrylic ester whose alcohol component contains more than 4 carbons; (ii) at least one (meth)acrylic ester whose alcohol component contains not more than 4 carbons; and (iii) acrylic acid and/or methacrylic acid at a total of at least 5 wt %. Also provided is a method of using the pressure-sensitive adhesive as a flame-retardant pressure-sensitive adhesive.

This application claims priority of German Patent Application No. 10 2019 217 753.0, filed Nov. 18, 2019, the entire contents of which are incorporated herein by reference.

The invention pertains to the technical field of pressure-sensitive adhesives, of the kind used across a very wide variety of different sectors of industry, for the temporary or permanent bonding of two substrates. Proposed more specifically is a pressure-sensitive adhesive having improved flame retardancy properties.

In numerous sectors of industry, such as in construction and in the vehicle and aircraft industries, increasingly demanding requirements are being imposed on the flame retardancy behaviour of installed components. A variety of test methods have been developed in this regard, adapted to specific requirements. For instance, components and auxiliaries which are used in aircraft construction are required to withstand a vertical Bunsen burner test. The same applies to adhesive tapes which are used in aircraft construction, for example, for securing insulation packages or floor coverings. For adhesive tapes of this kind, accordingly, there is a need for flame-retardant pressure-sensitive adhesives.

It has emerged, however, that the formulation of pressure-sensitive adhesives having good flame retardancy properties is not without problems. Flame retardants used frequently lead to massive losses in peel adhesion and/or to significant impairments in the shear strengths. In the fire scenario, moreover, many flame-retardant pressure-sensitive adhesive (PSA) compositions produce considerable amounts of soot, which is likewise undesirable. Generally speaking, therefore, there is a conflict of objectives between the requisite adhesive performance of the PSAs, on the one hand, and the likewise required flame retardancy properties, on the other.

There has been no lack of attempts in the past to mitigate this conflict of objectives.

For instance, U.S. Pat. No. 7,501,169 B2 describes an adhesive film composite comprising a substrate which is free from antimony and halogens and an adhesive polymer having an unhalogenated, phosphate-based flame retardant situated on it.

JP 2011148863 A discloses a composition comprising an acrylate polymer having a monomer basis comprising acrylic acid and (meth)acrylic esters having 1 to 8 carbon atoms in the alcohol component, a phosphazene flame retardant, a phosphoric ester flame retardant, a crosslinker and a tackifying resin, with defined relationships between polymer and flame retardants and also between the individual flame retardants themselves.

A similar approach is pursued by JP 2013018944 A, where the polymer has been synthesized from butyl acrylate, a monomer having a reactive functional group and/or an alkyl(meth)acrylate.

JP 2012031422 A describes a flame-retardant pressure-sensitive adhesive which comprises an acrylate ester copolymer at 100 parts by weight, ammonium polyphosphate at 50 to 115 parts by weight, aluminium hydroxide at 40 to 85 parts by weight, and aliphatic polyalcohols.

JP 2015067653 A discloses a substrate to which an adhesive composition has been applied, the composition comprising a tackifying resin at 100 parts by weight, a phosphinate-based flame retardant at 52 to 150 parts by weight and a phosphate ester-based flame retardant, which is present in liquid form at room temperature, at 10 to 50 parts by weight.

The subject of EP 3 362 531 A1 is a halogen-free, flame-retardant adhesive composition which comprises an adhesive and a flame retardant composition, the composition comprising a phosphoric ester compound and a flame retardant selected from melamine cyanurate, melamine pyrophosphate and phosphinate salt.

The goal for JP 2017132893 A was a pressure-sensitive adhesive for construction applications, having good peel adhesion on rough substrates and having excellent flame retardancy properties. This goal is said to be achieved by the curing of a composition comprising a polymerizable (meth)acrylic acid alkyl ester monomer at 100 parts by weight, a (meth)acrylic ester polymer having a weight-average molecular weight of 800 000 to 3 000 000 at 10 to 50 parts by weight, and a halogen-free, phosphoric ester-based flame retardant at 5 to 65 parts by weight, the latter based on the total weight of the two other components, where the fraction of the as yet unreacted monomer among the entirety of these monomers before curing is not more than 1.5 wt %. A similar approach is also pursued in JP 2017179329 A.

WO 2018 079853 A1 describes a layer of pressure-sensitive adhesive comprising 100 parts by weight of a (meth)acrylate ester polymer and 1 to 60 parts by weight of a halogen-free phosphate ester flame retardant, where the fraction of residual monomers is not more than 0.5 wt %.

CN 108329857 A has as its subject a single-sided adhesive tape whose adhesive layer is produced from polyacrylate, crosslinkers, first and second flame retardants and a solvent, with the first flame retardant being solid at room temperature and the second liquid at room temperature.

There is an ongoing demand for pressure-sensitive adhesives having good adhesive and flame retardancy properties. An object of the invention was to provide such a pressure-sensitive adhesive, exhibiting, in particular, good peel adhesion and shear strengths; additionally, minimal sooting in a fire scenario was desirable.

A first and general subject of the invention, which achieves this object, is a pressure-sensitive adhesive which comprises:
at least one poly(meth)acrylate and
at least one organophosphorus compound;

and is characterized in that

the monomer composition forming the basis for the poly(meth)acrylate comprises
at least one (meth)acrylic ester whose alcohol component contains more than 4 carbons;
at least one (meth)acrylic ester whose alcohol component contains not more than 4 carbons; and
acrylic acid and/or methacrylic acid at a total of at least 5 wt %.

A pressure-sensitive adhesive of this kind displays a balanced technical adhesive profile and a good flame retardancy effect.

A pressure-sensitive adhesive or PSA refers in accordance with the invention, as usual in the common usage, to a substance which at least at room temperature is durably tacky and also adhesive. A characteristic of a PSA is that it can be applied by pressure to a substrate and remains adhering there, with no closer definition of the pressure to be applied or of the period of exposure to this pressure. In general, though dependent in principle on the precise nature of the PSA and also of the substrate, the temperature and the atmospheric humidity, exposure to a brief, minimal pressure, which does not go beyond gentle contact for a short moment, is sufficient to achieve the adhesion effect; in other cases, a longer period of exposure to a higher pressure may also be necessary.

Pressure-sensitive adhesives have particular, characteristic viscoelastic properties which result in the durable tack and adhesiveness. A feature of these adhesives is that when they are mechanically deformed, there are processes of viscous flow and there is also development of elastic forces of recovery. The two processes have a certain relationship to one another in terms of their respective proportion, in dependence not only on the precise composition, the structure and the degree of crosslinking of the PSA, but also on the rate and duration of the deformation, and on the temperature.

The proportional viscous flow is necessary for the achievement of adhesion. Only the viscous components, frequently brought about by macromolecules with relatively high mobility, permit effective wetting and effective flow onto the substrate that is to be bonded. A high viscous flow component results in high pressure-sensitive adhesiveness (also referred to as tack or surface stickiness) and hence often also in a high adhesion. Highly crosslinked systems, crystalline polymers or polymers with glasslike solidification lack flowable components and in general are devoid of tack or at least possess only little tack.

The proportional elastic forces of recovery are necessary for the achievement of cohesion. They are brought about, for example, by very long-chain macromolecules with a high degree of coiling, and also by physically or chemically crosslinked macromolecules, and they allow the transmission of the forces that act on an adhesive bond. As a result of these forces of recovery, an adhesive bond is able to withstand a long-term load acting on it, in the form of a sustained shearing load, for example, to a sufficient degree over a relatively long time period.

For more precise description and quantification of the extent of elastic and viscous components, and also of the relationship between the components, the variables of storage modulus (G′) and loss modulus (G″) are employed, and can be determined by means of dynamic mechanical analysis (DMA). G′ is a measure of the elastic component, G″ a measure of the viscous component, of a substance. Both variables are dependent on the deformation frequency and the temperature.

The variables can be determined using a rheometer. In that case, for example, the material under investigation is exposed in a plate/plate arrangement to a sinusoidally oscillating shear stress. In the case of instruments operating with shear stress control, the deformation is measured as a function of time, and the time offset of this deformation is measured relative to the introduction of the shear stress. This time offset is referred to as the phase angle δ.

The storage modulus G′ is defined as follows: G′=(τ/γ)·cos(δ) (τ=shear stress, γ=deformation, δ=phase angle=phase shift between shear stress vector and deformation vector). The definition of the loss modulus G″ is as follows: G″=(τ/γ)·sin(δ) (τ=shear stress, γ=deformation, δ=phase angle=phase shift between shear stress vector and deformation vector).

A composition is considered in particular to be a pressure-sensitive adhesive, and is defined in particular as such for the purposes of the invention, when at 23° C., in the deformation frequency range from 10 to 10¹ rad/sec both G′ and G″ are situated at least partly in the range from 10³ to 10⁷ Pa. “Partly” means that at least a section of the G′ curve lies within the window subtended by the deformation frequency range from 10⁰ inclusive up to 10¹ inclusive rad/sec (abscissa) and by the G′ value range from 10³ inclusive to 10⁷ inclusive Pa (ordinate), and when at least a section of the G″ curve is likewise situated within the corresponding window.

A “poly(meth)acrylate” is understood to be a polymer which is obtainable by radical polymerization of acrylic and/or methacrylic monomers and also, optionally, further, copolymerizable monomers. More particularly a “poly(meth)acrylate” is a polymer whose monomer basis consists to an extent of at least 50 wt % of acrylic acid, methacrylic acid, acrylic esters and/or methacrylic esters, with acrylic esters and/or methacrylic esters being included at least fractionally, preferably to an extent of at least 30 wt %, based on the overall monomer basis of the polymer in question.

The PSA of the invention preferably comprises poly(meth)acrylate at a total of 30 to 70 wt %, more preferably at a total of 35 to 65 wt %, more particularly at a total of 40 to 60 wt %, such as, for example at 45 to 60 wt %, based in each case on the total weight of the PSA. Where one (single) poly(meth)acrylate or two or more poly(meth)acrylates may be present; in the rest of the present description as well, therefore, the plural expression “poly(meth)acrylates” includes in its definition, as does the expression “a total of”, not only the presence of one single poly(meth)acrylate but also the presence of two or more poly(meth)acrylates.

The glass transition temperature of the poly(meth)acrylate of the PSA of the invention is preferably <0° C., more preferably between −20 and −50° C., more particularly between −25 and −40° C., such as, for example, between −28 and −35° C. The glass transition temperature of polymers or of polymer blocks in block copolymers is determined in the present specification by means of dynamic scanning colorimetry (DSC). For this purpose, around 5 mg of an untreated polymer sample are weighed out into an aluminium crucible (25 μl volume) and closed with a perforated lid. Measurement takes place using a DSC 204 F1 from Netzsch. To render the system inert, operation takes place under nitrogen. The sample is first cooled to −150° C., then heated to +150° C. at a rate of 10 K/min, and cooled again to −150° C. The subsequent, second heating curve is run again at 10 K/min, and the change in the heat capacity is recorded. Glass transitions are recognized as steps in the thermogram (test method A).

The monomer composition forming the basis for the poly(meth)acrylate comprises, in accordance with the invention, at least one (meth)acrylic ester whose alcohol component contains more than 4 carbons. The (meth)acrylic ester whose alcohol component contains more than 4 carbons is preferably selected from the group consisting of isooctyl acrylate, isooctyl methacrylate, 2-ethylhexyl acrylate, 2-ethylhexyl methacrylate, 2-propylheptyl acrylate and 2-propylheptyl methacrylate. More preferably the (meth)acrylic ester whose alcohol component contains more than 4 carbons is 2-ethylhexyl acrylate.

(Meth)acrylic esters whose alcohol component contains more than 4 carbons are present in the monomer composition forming the basis for the poly(meth)acrylate of the PSA of the invention preferably at a total of 50 to 90 wt %, more preferably at a total of 60 to 80 wt %, and more particularly at a total of 65 to 75 wt %. The monomer composition may comprise one or more (meth)acrylic esters whose alcohol component contains more than 4 carbons; the expression “a total of” embraces both variants.

The monomer composition on which the poly(meth)acrylate is based further comprises, in accordance with the invention, at least one (meth)acrylic ester whose alcohol component contains not more than 4 carbons. The (meth)acrylic ester whose alcohol component contains not more than 4 carbons is preferably selected from the group consisting of n-butyl acrylate, n-butyl methacrylate and methyl acrylate, and more particularly the (meth)acrylic ester is methyl acrylate.

(Meth)acrylic esters whose alcohol component contains not more than 4 carbons are present in the monomer composition forming the basis for the poly(meth)acrylate of the PSA of the invention preferably at a total of 10 to 40 wt %, more preferably at a total of 15 to 30 wt %, and more particularly at a total of 20 to 25 wt %. The monomer composition may comprise one or more (meth)acrylic esters whose alcohol component contains not more than 4 carbon atoms; the expression “a total of” embraces both variants. In one particularly preferred embodiment, the monomer composition forming the basis for the poly(meth)acrylate of the PSA of the invention comprises methyl acrylate at more than 15 wt %, preferably more than 17%, such as, for example 20 to 30 wt %.

The monomer composition comprises acrylic acid and/or methacrylic acid preferably at a total of at least 6 wt %, more particularly at a total of at least 6.5 wt %. More preferably the monomer composition comprises acrylic acid at a total of at least 6 wt %, more preferably at a total of at least 6.5 wt %.

The poly(meth)acrylates are prepared preferably by conventional radical polymerizations or controlled radical polymerizations. The poly(meth)acrylates may be prepared by copolymerization of the monomers using customary polymerization initiators and also, optionally, chain transfer agents, with polymerization taking place at the customary temperatures in bulk, in emulsion, for example in water or liquid hydrocarbons, or in solution.

The poly(meth)acrylates are preferably prepared by copolymerization of the monomers in solvents, more preferably in solvents having a boiling range of 50 to 150° C., more particularly of 60 to 120° C., using 0.01 to 5 wt %, more particularly from 0.1 to 2 wt %, of polymerization initiators, based in each case on the total weight of the monomers.

All customary initiators are suitable in principle. Examples of radical sources are peroxides, hydroperoxides and azo compounds, for example dibenzoyl peroxide, cumene hydroperoxide, cyclohexanone peroxide, di-tert-butyl peroxide, cyclohexylsulfonyl acetyl peroxide, diisopropyl percarbonate, tert-butyl peroctoate and benzopinacol. Preferred radical initiators are 2,2′-azobis(2-methylbutyronitile) (Vazo® 67™ from DuPont), 2,2′-azobis(2-methylpropionitrile) (2,2′-azobisisobutyronitrile; AIBN; Vazo® 64™ from DuPont) and bis(4-tert-butylcyclohexanyl) peroxydicarbonate.

Preferred solvents for the preparation of the poly(meth)acrylates are alcohols such as methanol, ethanol, n- and isopropanol, n- and isobutanol, especially isopropanol and/or isobutanol; hydrocarbons such as toluene and, in particular, petroleum spirits with a boiling range of 60 to 120° C.; ketones, especially acetone, methyl ethyl ketone, methyl isobutyl ketone; esters such as ethyl acetate; and also mixtures of the aforementioned solvents. Particularly preferred solvents are mixtures which comprise isopropanol in amounts of 2 to 15 wt %, more particularly of 3 to 10 wt %, based in each case on the solvent mixture employed.

The poly(meth)acrylate or poly(meth)acrylates in the PSA of the invention are preferably crosslinked by linking reactions—especially in the sense of addition reactions or substitution reactions or else coordinative linking reactions—of the carboxylic acid functions present, using specific compounds—known as crosslinkers. The positions within the crosslinker molecules from which the macromolecules are attacked are also termed “reactive centres”. Crosslinker molecules contain two or more reactive centres and are therefore capable of linking two or more macromolecules to one another. Occasionally here there are also unwanted secondary reactions, in which the reactive centres of one and the same crosslinker molecule react with only one macromolecule.

It is possible in principle to distinguish between two types of crosslinkers:
1) Covalent crosslinkers, whose reactive centres attack the poly(meth)acrylate macromolecules covalently and therefore form a covalent bond between the reactive centre of the crosslinker and the attacked carboxylic acid group of the macromolecule. All types of reaction are contemplated in principle for the formation of covalent bonds.
2) Coordinative crosslinkers, whose reactive centres attack the poly(meth)acrylate molecules coordinatively and therefore form a coordinate bond between the reactive centre of the crosslinker and the attacked carboxylic acid group of the macromolecule. All types of reaction are contemplated in principle for the formation of coordinate bonds.

In one embodiment, the poly(meth)acrylate of the PSA of the invention is crosslinked at least covalently with one or more crosslinkers selected from the group consisting of glycidylamines, polyfunctional epoxides, polyfunctional aziridines and polyfunctional isocyanates. More preferably the poly(meth)acrylate of the PSA of the invention is crosslinked at least covalently with one or more crosslinkers selected from the group consisting of N,N,N′,N′-tetrakis(2,3-epoxypropyl)cyclohexyl-1,3-dimethylamine, N,N,N′,N′-tetrakis(2,3-epoxypropyl)-m-xylyl-α,α′-diamine, (3,4-epoxycyclohexyl)methyl 3,4-epoxycyclohexylcarboxylate, trimethylolpropane tris(2-methyl-1-aziridinepropionate), toluene diisocyanate (TDI), toluene 2,4-diisocyanate dimer, naphthylene 1,5-diisocyanates (NDI), o-toluene diisocyanates (TODI), diphenylmethane diisocyanates (MDI), triphenylmethane triisocyanates, tris(p-isocyanatophenyl) thiophosphate and polymethylene-polyphenyl isocyanate.

The poly(meth)acrylates of the PSA of the invention may have been crosslinked with one or more covalent crosslinkers, with one or more coordinative crosslinkers, or with a mixture of in each case one or more covalent and coordinative crosslinkers.

The PSA of the invention preferably comprises covalent crosslinkers at a total of 0.015 0.1 wt %, more preferably at a total of 0.02 to 0.075 wt %, based in each case on the total weight of the poly(meth)acrylates.

The PSA of the invention further comprises at least one organophosphorus compound. The organophosphorus compound is preferably halogen-free. The organophosphorus compound is preferably selected from the group consisting of phosphoric esters and iminophosphoranes.

More preferably the organophosphorus compound is an aromatic organophosphorus compound, especially an aromatic phosphoric ester. “Aromatic” here means that the compound in question has at least one aromatic structural unit, e.g. an aromatic substituent. With very particular preference the organophosphorus compound is selected from the group consisting of triphenyl phosphate, resorcinol bis(diphenyl phosphate) and bisphenol A bis(diphenyl phosphate). For example the organophosphorus compound is selected from resorcinol bis(diphenyl phosphate) and bisphenol A bis(diphenyl phosphate), and more particularly it is bisphenol A bis(diphenyl phosphate).

The PSA may comprise one or more organophosphorus compounds. Preferably the PSA of the invention comprises organophosphorus compounds at a total of at least 15 wt %, more preferably at least 18 wt %.

Further to the constituents recited thus far, the PSA of the invention may comprise additional constituents. In one embodiment the PSA of the invention comprises at least one tackifying resin, also referred to as a peel adhesion booster or tackifier. A “tackifier” in accordance with the general understanding of the skilled person is an oligomeric or polymeric resin which raises the autohesion (the tack; the intrinsic adhesiveness) of the PSA by comparison with the otherwise identical PSA containing no tackifier.

All known tackifying resins that are compatible with poly(meth)acrylates are suitable in principle. The PSA preferably comprises at least one tackifying resin selected from terpene-phenolic resins and rosin esters, more preferably at least one rosin ester. The rosin ester more particularly is a pentaerythritol rosin ester. It has emerged that in this way the flame retardancy effect can be further improved, this improvement being manifested more particularly in minimized burning lengths and in further-reduced sooting.

The PSA of the invention preferably comprises 18 to 28 wt % of tackifying resin, such as, in particular, 21 to 24 wt %.

The PSA of the invention may further comprise additional additives, examples being
plasticizers, e.g. low molecular mass poly(meth)acrylates, phthalates, water-soluble plasticizers;
functional additives, e.g. initiators and accelerators;
electrically conductive materials, e.g. conjugated polymers, doped conjugated polymers, metal pigments, metal particles, metal salts, metal-coated particles, e.g. silver-coated beads; graphite, conductive carbon blacks, carbon fibres, ferromagnetic additives;
foaming agents, expandants, expandable hollow spheres; the latter, however, only in an amount that does not adversely affect the flame retardancy effect;
compounding agents, nucleating agents;
aging inhibitors, e.g. primary and secondary antioxidants; light stabilizers, antiozonants;
pulverulent and granular fillers, dyes and pigments, e.g. fibres, carbon blacks, zinc oxides, titanium dioxide, chalks, silicas, silicates, solid or hollow glass spheres, solid or hollow polymer spheres, solid or hollow ceramic spheres, microspheres made from other materials; and
organic fillers.

In one embodiment the PSA comprises at least one iminophosphorane and/or at least one amine. Preferred iminophosphoranes are cyclophosphazenes. With particular preference the PSA comprises at least one phenoxy-substituted cyclophosphazene and/or at least one sterically hindered N-alkoxyamine. More particularly the PSA comprises at least one sterically hindered N-alkoxyamine, for example a reaction product of N,N″-1,2-ethanediylbis(1,3-propanediamine) with cyclohexane and with peroxidized N-butyl-2,2,6,6-tetramethyl-4-piperidineamine-2,4,6-trichloro-1,3,5-triazine (CAS No. 191680-81-6).

It has emerged that with adjuvants of this kind, the flame retardancy performance of the PSA can be optimized still further.

The PSA of the invention preferably comprises 15 to 35 wt %, preferably 20 to 30 wt %, of flame retardant(s). The term “flame retardant” embraces, in particular, organophosphorus compounds, iminophosphoranes and amines, though this should not be understood as imposing any limitation.

The PSA of the invention is produced preferably from dispersion or solution by sequential incorporation of the components, subsequent shaping of the dispersion or solution to form a web, and subsequent removal of the solvent used. Preferred solvents are those already described in connection with the preparation of the poly(meth)acrylates.

A further subject of the invention is the use of a pressure-sensitive adhesive of the invention as a flame-retardant PSA, more particularly as a flame-retardant PSA in the fitting-out of aircraft, trains, boats, vehicles and buildings.

In one embodiment, the PSA of the invention is used in this context for producing permanent adhesive bonds in interiors, more preferably for the fixing of thermal insulation material, more particularly between inner and outer walls; for fixing non-textile floorings in wet rooms, e.g. in kitchens and toilets; for fixing floor coverings in general; as an adhesive for moisture barrier applications and/or in corrosion control applications, and/or for fixing mirrors and/or lights.

In another embodiment the PSA of the invention is used for producing adhesive bonds, preferably permanent adhesive bonds, in electric vehicles. In this context the PSA is used more preferably for producing adhesive bonds in the battery, especially for producing adhesive mounting bonds, for the purpose, for example, of bonding fire-resistant materials between battery cells; for bonding flexible circuit boards; for bonding foams, more particular silicone foams; for producing bonds for the purpose of the electrical insulation of battery modules and/or battery components, more particularly the electrical insulation of battery cells (battery cell wrapping) and/or of the heating/cooling plate.

### EXAMPLES

Raw materials used:
Butyl acrylate: CAS number 141-32-2
Ethylhexyl acrylate: CAS number 103-11-7
Methyl acrylate: CAS number 96-33-3
Acrylic acid: CAS number 79-10-7
Vazo 67: 2,2′-Azodi(2-methylbutyronitrile), CAS number 13472-08-7, Akzo Nobel
Perkadox 16: Bis(4-tert-butylcyclohexanyl) peroxydicarbonate, CAS number 15520-11-3, Akzo Nobel
Dertophene T 105: Terpene-phenolic resin, softening point around 105° C.; MW˜850 g/mol; DRT
Foral 105 E: Hydrogenated pentaerythritol rosin ester, softening point around 100° C.; MW˜1002 g/mol; Eastman
Erisys GA 240: N,N,N′,N′-Tetrakis(2,3-epoxypropyl)-m-xylene-α,α′-diamine, Emerald Performance Materials
GC-BDP: Bisphenol A bis(diphenylphosphate), CAS number 5945-33-5; GREENCHEMICALS SPA
GC-TPP: Triphenyl phosphate, CAS number 115-86-6; GREENCHEMICALS SPA
NORD-MIN RDP: Tetraphenyl-m-phenylenebis(phosphate) (resorcinol bis(diphenyl phosphate)), CAS number 57583-54-7; Nordmann
Rabitie FP 110: Phenoxyphosphazene; Fushimi Pharmaceutical Co., Ltd.
Flamestab NOR 116 FF: CAS number 191680-81-6; BASF SE

### Preparation of the Polyacrylates

Polyacrylate 1

A conventional 2 L glass reactor suitable for radical polymerizations with evaporative cooling was charged with 300 g of a monomer mixture composed of 201 g of n-butyl acrylate, 90 g of 2-ethylhexyl acrylate and 9 g of acrylic acid and also with 200 g of acetone: special-boiling-point spirit 60/95 (1:1). After nitrogen gas had been passed through the reactor for 45 minutes with stirring, the reactor was heated to 58° C. and 0.15 g of 2,2′-azodi(2-methylbutyronitile (Vazo 67®, Akzo Nobel) in solution in 6 g of acetone was added. The external heating bath was then heated to 75° C. and the reaction was carried out constantly at this external temperature. After a reaction time of 1 h a further 0.15 g of Vazo 67®, in solution in 6 g of acetone, was added. After 3 hours the batch was diluted with 90 g of special-boiling-point spirit 60/95.

After a reaction time of 5 h 30 min, 0.45 g of bis(4-tert-butylcyclohexanyl) peroxydicarbonate (Perkadox 16®, Akzo Nobel) in solution in 9 g of acetone was added. After a reaction time of 7 hours, a further 0.45 g of bis(4-tert-butylcyclohexanyl) peroxydicarbonate (Perkadox 16®, Akzo Nobel), in solution in 9 g of acetone, was added. After a reaction time of 10 hours, the batch was diluted with 90 g of special-boiling-point spirit 60/95. After a reaction time of 24 h, the reaction was terminated and the batch was cooled to room temperature.

The resultant polyacrylate 1 has a glass transition temperature (T_{g}) by test method A of −46° C.

Polyacrylate 2

A conventional 2 L glass reactor suitable for radical polymerizations with evaporative cooling was charged with 300 g of a monomer mixture composed of 219 g of 2-ethylhexyl acrylate, 60 g of methyl acrylate and 21 g of acrylic acid and also with 200 g of acetone: special-boiling-point spirit 60/95 (1:1). After nitrogen gas had been passed through the reactor for 45 minutes with stirring, the reactor was heated to 58° C. and 0.15 g of 2,2′-azodi(2-methylbutyronitrile (Vazo 67®, Akzo Nobel) in solution in 6 g of acetone was added. The external heating bath was then heated to 75° C. and the reaction was carried out constantly at this external temperature. After a reaction time of 1 h a further 0.15 g of Vazo 67®, in solution in 6 g of acetone, was added. After 3 hours the batch was diluted with 90 g of special-boiling-point spirit 60/95.

After a reaction time of 5 h 30 min, 0.45 g of bis(4-tert-butylcyclohexanyl) peroxydicarbonate (Perkadox 16®, Akzo Nobel) in solution in 9 g of acetone was added. After a reaction time of 7 hours, a further 0.45 g of bis(4-tert-butylcyclohexanyl) peroxydicarbonate (Perkadox 16®, Akzo Nobel), in solution in 9 g of acetone, was added. After a reaction time of 10 hours, the batch was diluted with 90 g of special-boiling-point spirit 60/95. After a reaction time of 24 h, the reaction was terminated and the batch was cooled to room temperature.

The resultant polyacrylate 2 has a glass transition temperature (T_{g}) by test method A of about −34° C.

Production of the Pressure-Sensitive Adhesives:

### Example 1

The terpene-phenolic resin Dertophene T 105 was dissolved in the solution of the polyacrylate 1 in a weight ratio of 70:30, based on the polymer solids content. Bisphenol A diphenyl phosphate was added to this solution, giving a 30% mass fraction of solids in the mixture. The mixture was then diluted with acetone, to reach a final solids content of 38%. The mixture was placed on a roller bed until a homogeneous solution had formed (around 12 h). Thereafter a crosslinker solution (3 wt % Erysis GA 240 in acetone) was added at 0.075 part by weight, based on 100 parts by weight of polymer, and the adhesive was coated in a thickness of 100 μm onto a siliconized film, using a bar coater on a laboratory coating bench. The coatings were subsequently dried at 120° C. for 15 min.

### Examples 2-9

The procedure in each case was as in Example 1. The composition of the adhesives is reported in Table 1.

Production of the Test Specimens:

For the tests, the adhesive was laminated with a trichloroacetic acid-etched PET film 23 μm thick. The adhesive-free side of the film additionally had a layer of adhesive 100 μm thick laminated to it, to produce a double-sided tape.

Test Methods:

Peel Adhesion

The peel adhesion to CRES steel was determined under testing conditions of 23° C.+/−1° C. temperature and 50%+/−5% relative humidity.

A strip of the adhesive tape specimen 20 mm wide was applied to steel plates which beforehand had been washed twice with acetone and once with isopropanol and left thereafter to lie in the air for 5 minutes to allow the solvent to evaporate. The pressure-sensitive adhesive strip was pressed onto the substrate twice with an applied pressure corresponding to a weight of 2 kg. The adhesive tape was subsequently peeled from the substrate immediately at an angle of 90° and at a velocity of 300 mm/min. The results of measurement are reported in N/cm as an average from three measurements.

Static Shear Test

The shear strength was determined under testing conditions of 23° C.+/−1° C. temperature and 50%+/−5% relative humidity.

The test specimens were trimmed to a width of 13±0.2 mm and stored under the conditions for at least 16 h. Testing took place using 50×25 mm ASTM steel plates with a thickness of 2 mm and with a 20 mm marking line, these plates, prior to bonding, having been cleaned intensely with acetone a number of times and left thereafter to dry for 1-10 min. The bond area was 13×20±0.2 mm. The test strips were applied in longitudinal direction centrally to the substrate, avoiding air inclusions by running over them with the finger or using a suitable wiping device, application taking place such that the top edge of the test specimen lay precisely at the 20 mm marking line.

Because the specimens tested were double-sided, the reverse side was taped off with aluminium foil. The freely protruding end was taped off with paper or a sheet of card. The adhesive strip was then rolled down back and forth 2 times with a 2 kg roller. After it had been rolled down, a belt loop (weight 5-7 g) was attached on the protruding end of the adhesive tape.

An adapter plaque was then mounted on the front side of the shear test plate with a screw and nut. In order to ensure a secure seating of the adapter plaque on the plate, the bolt was tightened forcefully by hand.

The plate thus prepared was mounted by means of the adapter plaque on a clock counter by means of a hook; a 1 kg weight was then suspended smoothly in the belt loop.

The adhesion time between rolling down and loading was 12 min. Measurements were made of the time in minutes until the bond fails; the results of measurement are on average from three measurements.

12 s Vertical Bunsen Burner Test

The 12 s vertical Bunsen burner test is carried out according to FAR 25.853 (Appendix F Part I (a)(1)(II)): The sample is held in a vertical position in a U-frame, with the sample hanging free, in other words without being bonded on a substrate, and a Bunsen burner flame is applied from below for 12 s. When the flaming time of 12 s has elapsed, the burner is removed and the material is observed. The following parameters are documented:

a) average afterburn time: time in s for which the sample burns after the burner flame has been removed;

b) average drop burning time: time in s for which the burning material continues to burn after having dropped from the sample;

c) average burning length: distance from the initial sample edge to the most remote point at which the sample has undergone damage.

At least 3 test specimens were tested.

The specimens are considered to be flame retardant if they complied with the requirements below in accordance with the FAR 25.853 standard (Appendix F Part I (a)(1)(II)):

Average afterburn time: <15 s

Average drop burn time: <5 s

Average burning length: <203.2 mm.

The results of tests are contained in Table 1.

TABLE 1
Compositions of the examples and results

| | Example No. | | | | | | | | |
|---|---|---|---|---|---|---|---|---|---|
| Composition | 1 (comp.) | 2 | 3 | 4 | 5 | 6 | 7 | 8 | 9 |
| Polyacrylate 1 | 49% | | | | | | | | |
| Polyacrylate 2 | | 49% | 49% | 49% | 55.3% | 55.3% | 55.3% | 55.3% | 55.3% |
| Dertophene T 105 | 21% | 21% | | | | | | | |
| Foral 105-E | | | 21% | 21% | 23.7% | | | 23.7% | 23.7% |
| Foral 85-E | | | | | | 23.7% | | | |
| Foral AX | | | | | | | 23.7% | | |
| Bisphenol A | 30% | 30% | 30% | 20% | 20% | 20% | 20% | | |
| bis(diphenylphosphate) | | | | | | | | | |
| Resorcinol bis(diphenyl | | | | | | | | 20% | |
| phosphate) | | | | | | | | | |
| Triphenyl phosphate | | | | | | | | | 20% |
| Rabitle FP 110 | | | | 10% | | | | | |
| Flamestab NOR 116 FF | | | | | 1% | 1% | 1% | 1% | 1% |
| Erysis GA 240 | 0.04% | 0.04% | 0.04% | 0.04% | 0.04% | 0.04% | 0.04% | 0.04% | 0.04% |
| | Example No. | | | | | | | | |
| | 1 | 2 | 3 | 4 | 5 | 6 | 7 | 8 | 9 |
| Peel adhesion 90° CRES | 7.2 | 12.9 | 10.5 | 11.0 | 12.0 | 5.6 | 5.1 | 3 | 4.4 |
| [N/cm] | | | | | | | | | |
| Holding power RT [min] | 633 | 3312 | 2888 | 4595 | 7213 | 2140 | 1532 | 718 | 6878 |
| Burning length [mm] | 213 | 175 | 165 | 78 | 25 | 75 | 200 | 28 | 62 |
| Afterburn time [s] | 0 | 14 | 7 | 0 | 0 | 0 | 8.4 | 0 | 0 |
| Afterburn time, drop [s] | 0 | 0 | 1 | 0 | 0 | 1 | 1 | 0 | 0 |
| Sooting | Yes | Yes | No | No | No | No | No | No | No |

1. Pressure-sensitive adhesive comprising:
at least one poly(meth)acrylate; and
at least one organophosphorus compound;
wherein
the monomer composition forming the basis for the poly(meth)acrylate comprises
at least one (meth)acrylic ester whose alcohol component contains more than 4 carbons;
at least one (meth)acrylic ester whose alcohol component contains not more than 4 carbons; and
acrylic acid and/or methacrylic acid at a total of at least 5 wt %.

2. Pressure-sensitive adhesive according to claim 1, wherein
the glass transition temperature of the poly(meth)acrylate by test method A is <0° C.

3. Pressure-sensitive adhesive according to claim 1, wherein
the at least one (meth)acrylic ester whose alcohol component contains more than 4 carbon atoms is present in the monomer composition forming the basis for the poly(meth)acrylate at a total of 50 to 90 wt %.

4. Pressure-sensitive adhesive according to claim 1, wherein
the at least one (meth)acrylic ester whose alcohol component contains not more than 4 carbons is present in the monomer composition forming the basis for the poly(meth)acrylate at a total of 10 to 40 wt %.

5. Pressure-sensitive adhesive according to claim 1, wherein
the monomer composition forming the basis for the poly(meth)acrylate comprises methyl acrylate at more than 15 wt %.

6. Pressure-sensitive adhesive according to claim 1, wherein
the pressure-sensitive adhesive comprises organophosphorus compounds at a total of at least 15 wt %, based on a total weight of the pressure-sensitive adhesive.

7. Pressure-sensitive adhesive according to claim 1, wherein
the organophosphorus compound is an aromatic organophosphorus compound.

8. Pressure-sensitive adhesive according to claim 1, wherein
the organophosphorus compound is a bisphenol A bis(diphenyl phosphate).

9. Pressure-sensitive adhesive according to claim 1, wherein
the pressure-sensitive adhesive comprises at least one rosin ester.

10. Pressure-sensitive adhesive according to claim 9, wherein
the rosin ester is a pentaerythritol rosin ester.

11. Pressure-sensitive adhesive according to claim 1, wherein
the pressure-sensitive adhesive comprises at least one iminophosphorane.

12. Pressure-sensitive adhesive according to claim 1, wherein
the pressure-sensitive adhesive comprises at least one amine, and optionally additionally at least one iminophosphorane.

13. A method comprising adhesive bonding of at least one substrate with a flame-retardant pressure-sensitive adhesive, wherein the flame-retardant pressure-sensitive adhesive is the pressure-sensitive adhesive according to claim 1.
